(19) United States
(12) Patent Application Publication
(10) Pub. No.: US 2006/0067074 A1
(43) Pub. Date: Mar. 30, 2006

(54) Dynamic decoration light

(76) Inventor: Ming-Kuei Lin, Taipei Hsien (TW)

Correspondence Address: DAVID E. DOUGHERTY;Dennison, Schultz, Dougherty & Macdonald, Suite 105, 1727 King Street, Alexandria, VA, 22314-2700, US

(21) Appl. No.: 10/951,806

(22) Filed: Sep. 29, 2004

(51) Int. Cl. F21V 5/00

(52) U.S. Cl. 362/244; 362/231

(57) ABSTRACT

A dynamic decoration light is consisted of a base, at least one display plate, a plurality of light refractor cones, a plurality of LED lights, and control circuit. The display plate is transparent with a plurality of conical refractors fixed on the rear side thereof. While the cone surface of light refractor form into radial wave surface, and each top side of the light refractor is attached on the rear side of the display plate. The center of the bottom side of the conical refractor is fixed with a LED light that is controlled by control circuit to display diversified glistening light. When the device being applied, various colors of LED lights pass through the conical refractor and then show radial dynamic light on the display plate for visual amusement.

### BACKGROUND OF THE INVENTION

The present invention relates to a dynamic decoration light, more particularly, to a dynamic Decoration light with a plurality of LEDs (Light-Emitting Diode) emitting glistening (flickering) lights, which flash through a plurality of conical refractor and display dynamic radiator lights on a transparent display plate, and therefore attain the decoration effect of dynamic light.

According to the description of the prior art, Interior design usually applies some light decorators to provide better appearance in a room. Most of current light decorators belongs to the skillfullness of static design, and more convenient to lose the light decorators' characteristics of interesting and curiosity. Therefore they can not satisfy the user's mental needs of curiosity and interesting, which become the defects of conventional light decorator. The present invention provides a kind of dynamic light design.

### SUMMARY OF THE INVENTION

It is therefore a primary object of the present invention to provide a dynamic decoration light which deploy a plurality of transparent conical refractors with radial wave surface on the back of a transparent display plate. A LED light is set up at the center bottom of each conical refractor, and control circuit is used to control LED lights to produce diversified light. Various color lights emitted from LEDs pass through the conical refractors and show radial dynamic light on the display plate. The dynamic light present on the front side of the display plate forms an animated firework with decoration effect.

A further object of the present invention is to provide a dynamic decoration light which set up a light sensor bar at the lower part of each conical refractor respectively, and a plurality of transverse slots in the same distance is arranged on the light sensor bar while a LED light is installed under the cross section of the bottom of the light sensor bar. When switch on the dynamic decoration light on, the control circuit is used to control the light emit of each LED, and make light emit from the LED to light sensor bar, through the cross section of the bottom side thereof and form generic flash effect on each transverse slot of the light sensor bar. Then a drag-like dot line is produced under the dynamic light of conical refractor.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment in accordance with the present invention;

FIG. 2 is an explosive view of the embodiment of the present invention shown in FIG. 1;

FIG. 3 is a rear view of the embodiment shown in FIG. 1;

FIG. 4 is a perspective view of an embodiment of a refractor according to the present invention;

FIG. 4A is a cross-sectional view of the refractor shown in FIG. 4;

FIG. 5 is a perspective view of another embodiment of a refractor according to the present invention;

FIG. 5A is a cross-sectional view of the refractor shown in FIG. 5;

FIG. 6 is a perspective view of a further embodiment of a refractor according to the present invention;

FIG. 6A is a cross-sectional view of the refractor shown in FIG. 6;

FIG. 7 is a cross-sectional view of the embodiment shown in FIG. 1;

FIG. 7A is a partial enlarged view of FIG. 7;

FIG. 8 is a front view of the embodiment shown in FIG. 1 while being applied.

FIG. 9 is a cross-sectional view of another embodiment according to the present invention;

FIG. 9A is a partial enlarged view of FIG. 9;

FIG. 10 is a front view of the embodiment shown in FIG. 9 while being applied.

FIG. 11 is a perspective view of a further embodiment in accordance with the present invention.

### DETAILED DESCRIPTION OF THE PREFERRED EMBODIMENT

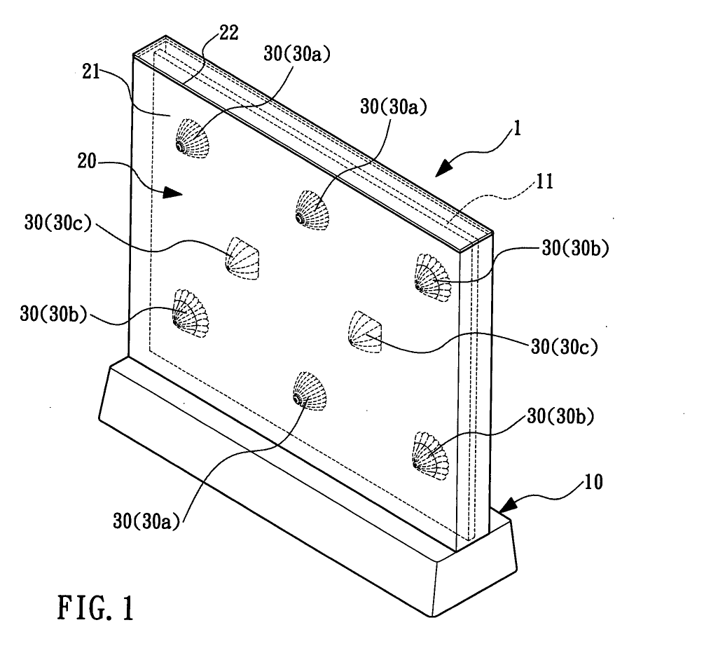

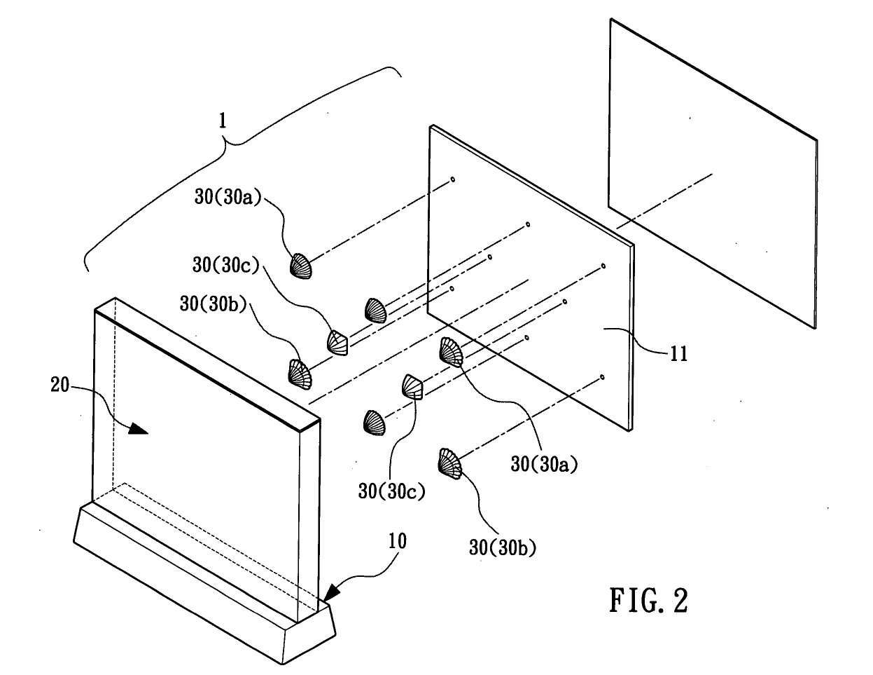

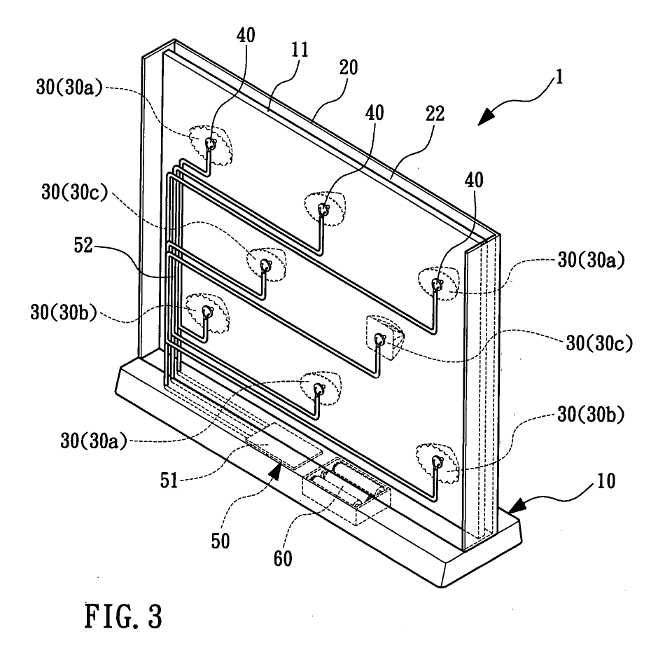

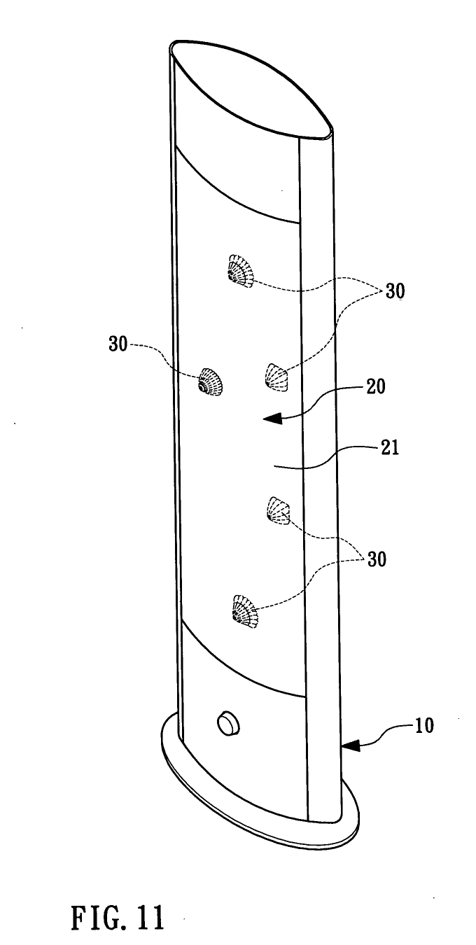

Refer to FIG. 1, FIG. 2 & FIG. 3, the present invention includes a base 10, at least one display plate 20, a plurality of conical refractors 30, a plurality of LED lights 40, control circuit 50, and a power supply 60. The base 10 is hollow base, and has no restriction on the shape of outlook as per FIG. 1 or FIG. 11 while other components are fixed inside the inner space of the base 10. And at least one display plate 20 made from transparent thin plastic plate is set on the base 10 with optional colors. The front side of the display plate 20 faces outside as main view.

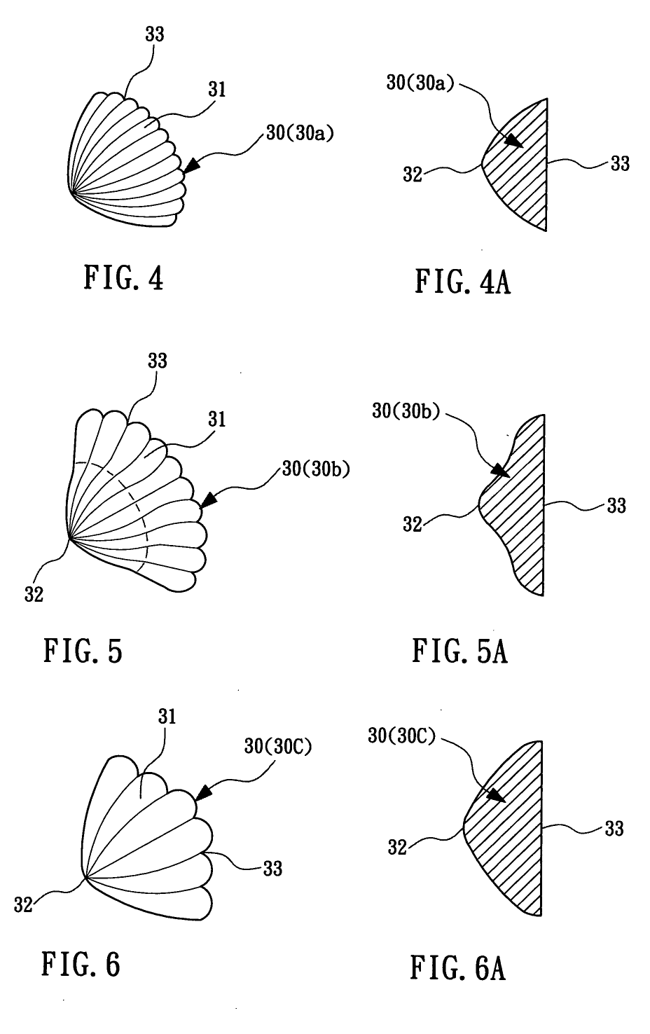

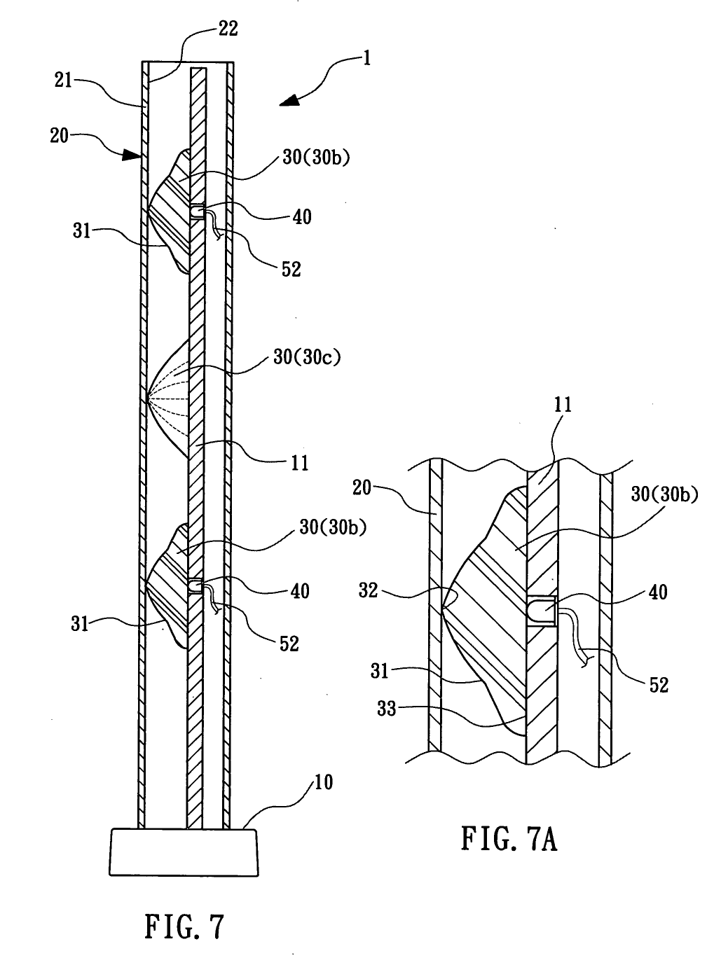

The conical refractor 30 is a kind of transparent cone made from transparent plastic materials by injection molding. The appearance of the conical refractor could be a round shape 30a, 30b shown in FIG. 4-4A-5-5A, or a pyramidal shape 30c shown as per FIG. 6-6A. Every cone surface of light refractor 30 (30a-30b-30c) is made into radial wave surface 31, while the top 32 of each of the conical refractors 30 is attached on the back 22 of display plate 22 respectively and deployed on different position. For convenient assembling, a holding plate 11 is set up at the back of the display plate 20 to hold the cone base 33 of each light refractor 30 firmly so that each top 32 of the light refractor 20 can easily fix on the back 22 of the display plate 20. The display plate 20 can be assembled from inner and outer layer structure to prevent light refractors 30 from being seen outside directly.

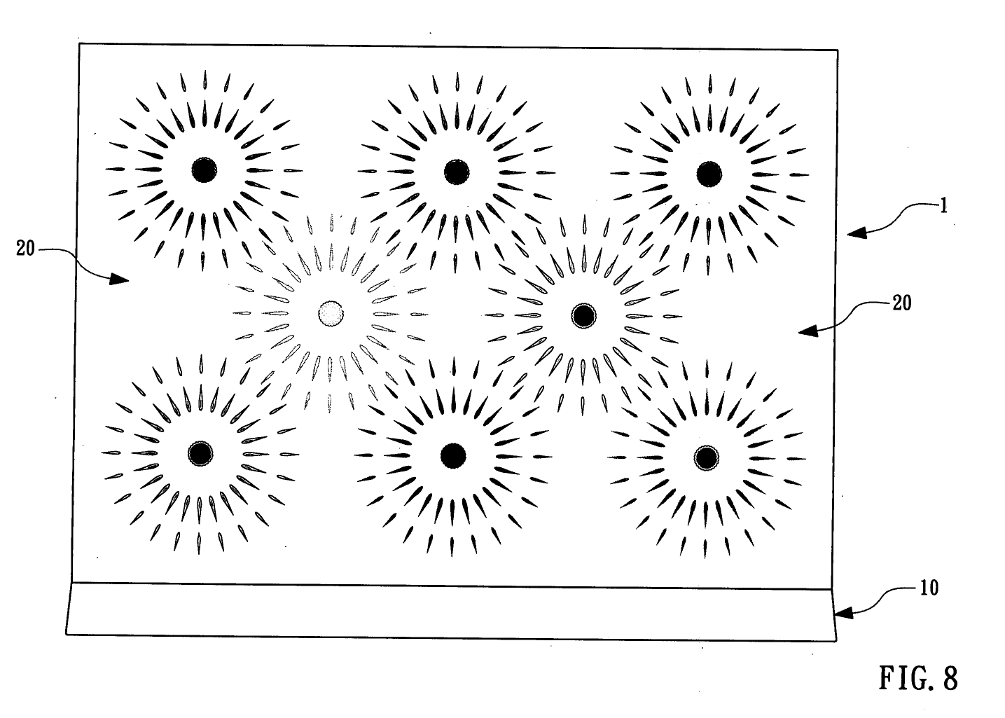

The LED light 40 is disposed on the center of the cone base 33 of the conical refractor 30 The light from the LED light 40 is refracted into the center of the light refractor 30 though the cone base 33 thereof. By the reflecting function of radial wave surfaces of light refractor 30, the light of each LED light 40 separates into several light beams, flashing on the surface of the display plate 20. As shown in FIG. 8, looking at the front side 21 of the display plate 20, the dynamic radial light glistens like fireworks explosive at night and therefore has the amusement effects. The control circuit 50 consists of a circuit board 51 and a plurality of wires 52 for controlling each of the LED lights 40 to display various flashing light combinations, such as all LED lights switch on or off simultaneously, or alternatively to increase diversity of the radial light. The power supply can be inner battery charge or outer plug cord for providing the electricity necessarily to the control circuit 50 and LED lights 40.

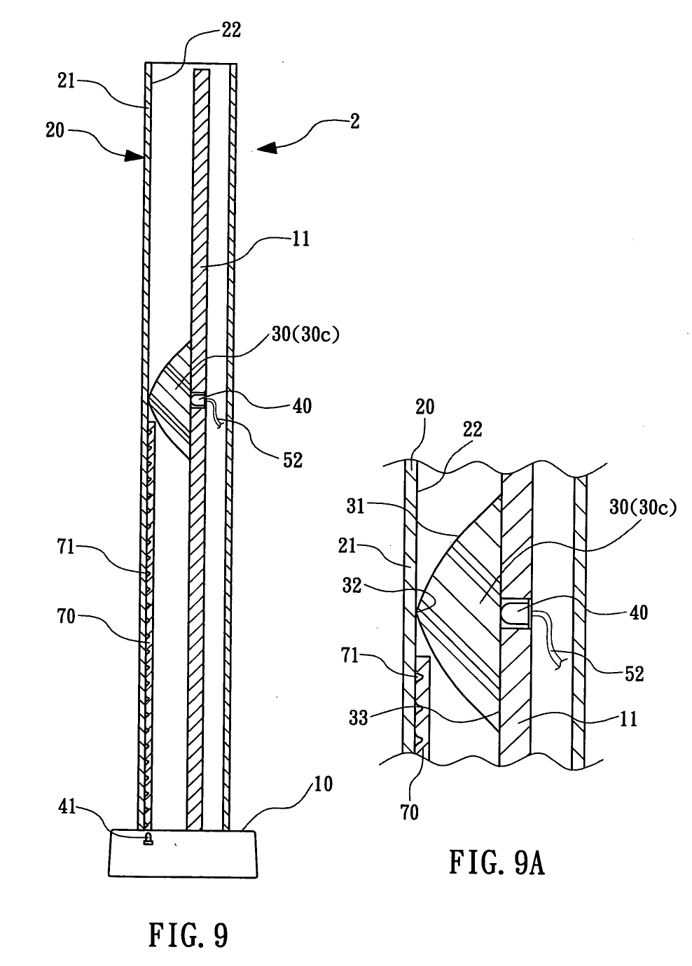

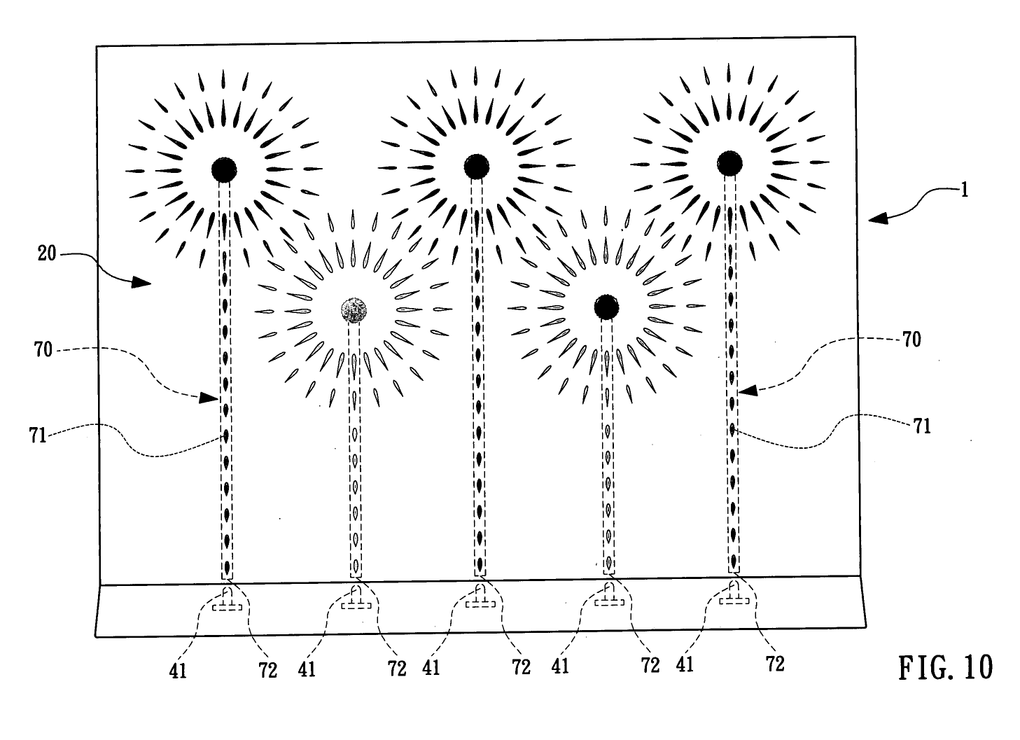

Refer to FIG. 9-9A-10, another embodiment of the dynamic decoration light 2 further having a light sensor bar 70 set under each light refractor 30 respectively, and a plurality of transverse slots 71 is set at the same distance on the light sensor bar 70 while a LED light 41 is installed at the cross section of the bottom side thereof. When being applied, the control circuit 50 is used to control the light emitting of each LED light 41. The light emits from the LED light 41 passes through the light sensor bar 70, out from the transverse slots 71 thus produces flashing effect on each transverse slot 71 of light sensor bar 70. The light beams form a drag-like dot line under the dynamic light of the conical refractor 30 as shown in FIG. 10. Therefore, the dynamic light looks more like an animated firework show.

What is claimed is:

1. A dynamic decoration light comprising a base, at least one display plate, a plurality of conical refractors, a plurality of LED lights, control circuit, and a power supply, wherein:
the base is hollow with at least one display plate thereon;
the display plate is a transparent thin plastic plate with the front side facing outwards;
the conical refractors is transparent with radial wave surface; each of the conical refractors is attached on the rear of the display plate and is deployed on different positions;
the LED light is arranged on the center of the bottom of the conical refractor;
the control circuit is for controlling the light emitting of the LED light; and
the power supply is for providing the electricity to the control circuit and the LED light.

2. The dynamic decoration light as claimed in claim 1, wherein the conical refractor is cone shape or pyramidal shape.

3. The dynamic decoration light as claimed in claim 1, wherein the colors of each of the LED light is different.

4. The dynamic decoration light as claimed in claim 1, wherein the color of the display plate is different.

5. The dynamic decoration light as claimed in claim 1, wherein the time of each LED light to emit light is different.

6. The dynamic decoration light as claimed in claim 1, wherein

7. The dynamic decoration light as claimed in claim 6, wherein a plurality of transverse slot is arranged on the light sensor bar in equal distance with each other.
